(19) United States
(12) Patent Application Publication
(10) Pub. No.: US 2014/0183853 A1
(43) Pub. Date: Jul. 3, 2014

(54) Case Covering As Advertising Medium

(71) Applicant: Carsten Dziawer, Neu Wulmstorf (DE)

(72) Inventor: Carsten Dziawer, Neu Wulmstorf (DE)

(21) Appl. No.: 14/237,371

(22) PCT Filed: May 31, 2012
(86) PCT No.: PCT/EP2012/060298

§ 371 Date: Feb. 6, 2014

(30) Foreign Application Priority Data
Aug. 9, 2011 (DE) 10 2011 109 751.5

(51) Int. Cl. B42D 15/00

(52) U.S. Cl. CPC B42D 15/00
USPC 283/56

(57) ABSTRACT

The invention relates to a covering for suitcases, comprising a tubular cover which is capable of being drawn back or—synonymously—pulled respectively over a suitcase and which is open on both sides and comprises at least two different portions produced from different materials, wherein at least one portion of the covering joins the two tube openings and consists of a resilient material, and at each tube opening a belt which traverses the tube opening and is provided with a re-closable mechanism, wherein the ends of the belt are fastened opposite each other at the respective tube opening.

### FIELD OF THE INVENTION

The invention relates to a covering for a case, which can be easily fastened to a suitcase and removed from it again. The covering can be provided with an imprint or a patch which can be used for advertising purposes.

### BACKGROUND OF THE INVENTION

Suitcases have large areas which as a rule are of one colour and which are visible in public places. These areas are unused as a rule, although it would be possible to use them as advertising spaces. Various systems which are intended to be used to make these areas of the suitcases usable are known from the prior art. DE 103 23 119 A1 discloses a rigid transparent protective sleeve for a case which is used for advertising purposes. DE 201 20 865 U1 describes a case which is covered with an advertising or decorative film. EP 1 511 406 discloses a bag structure which contains a removable plate in which advertising media or information material can be incorporated. Many other systems for using cases and bags as advertising media or protective sleeves for cases or bags are known.

All these systems require a carrier system which is adapted to the respective case and which either has to be already integrated into the case during the production of the case or has to be incorporated into the case subsequently in a complicated manner. As a rule, these systems can also not easily be removed from the case.

U.S. Pat. No. 2,711,234 discloses a protective sleeve consisting of stretch material throughout for a case. It is not possible for advertising to be applied to the stretching protective sleeve. U.S. Pat. No. 5,255,765 relates to two protective coverings capable of being connected to each other by way of buckles for a case, which coverings are capable of being released from the case only in a very awkward manner.

The object has therefore been to develop a sleeve for a case, which avoids the draw-backs of the prior art described above. This object is attained by the covering, the features of which are defined in the claims and in the description.

### SUMMARY OF THE INVENTION

The invention relates to a covering for suitcases, comprising a tubular cover which is capable of being drawn back with two tube openings over a suitcase and which comprises along a periphery of the tube at least two different portions produced from different materials, at least one portion of the cover joining the two tube openings and consisting of a resilient material, and at each tube opening a belt which traverses the tube opening and is provided with a re-closable mechanism, the ends of the belt being fastened opposite each other at the respective tube opening.

The cover has a longitudinal extension, at the ends of which one of the two tube openings is provided in each case. The cover is preferably capable of being drawn back over the case completely. The case has a bottom half shell and a top half shell. The opening gap formed by the two half shells extends around the four narrow sides of the case, the lateral narrow sides and the handle side and standing side. In this case the edges of the tube openings preferably rest exclusively on the sides and also do not cover the standing side and/or handle side of the case even in part. The longitudinal extension of the cover is shorter than a length of the lateral sides of the case in the longitudinal direction.

A portion of the covering can be capable of being printed on or provided with a patch.

At least one imprint or advertising imprint can be applied to the covering or the patch.

The covering can, in addition, comprise a further opening on the side of the cover as a gap for a handle of the case.

At least one portion of the covering can consist of a non-resilient material.

The at least one portion of the resilient material can occupy at most 5%, 10%, 15%, 20% or 25% of the area of the cover.

It is preferable for exactly one portion of the cover to be formed from resilient material. The exactly one portion of resilient material is intended to be laid upon one of the two lateral narrow sides of the case.

The advertising imprint can be applied in the portion which consists of non-resilient material. As a result, the advertising imprint is not distorted while the covering is used. The advertising imprint can also be applied to a carrier which in turn is capable of being inserted into a pocket provided on the cover.

Two advertising imprints can be applied to opposite sides of the cover.

The belt can comprise two parts and the re-closable mechanism can be attached to the free ends of the belt parts.

The covering can be drawn back onto a suitcase and can be fixed to the suitcase by closing the re-closable mechanism.

### BRIEF DESCRIPTION OF THE FIGURES

FIGS. 1 to 5 show a case to which a cover according to the invention has been applied, from five different views of the sides (FIGS. 1 to 5 in the sequence: left-hand narrow side, front wide side, right-hand narrow side, rear wide side, plan view).

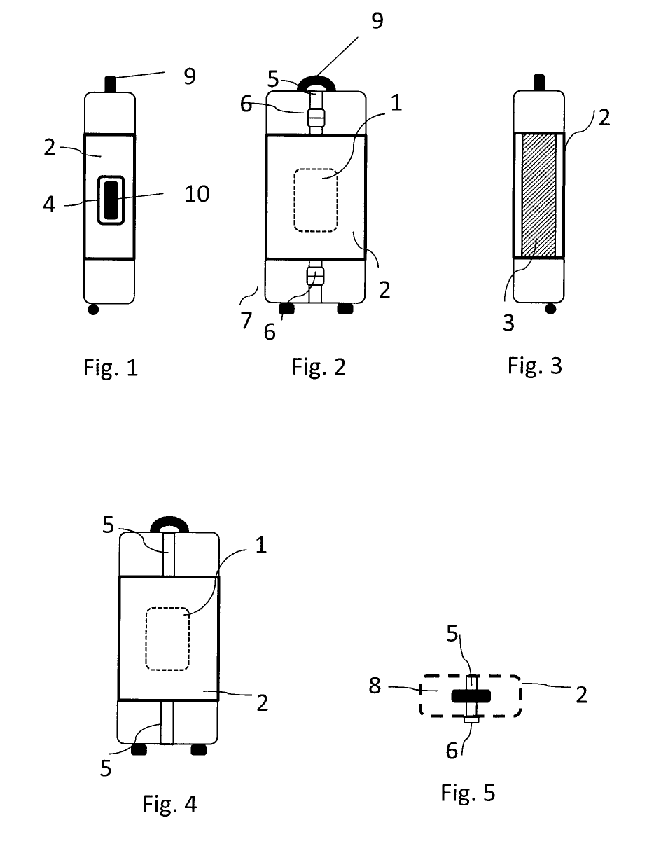

FIGS. 6 to 10 show the covering according to the invention without the case from the same views of the sides as in FIGS. 1 to 5, in which the illustration [of] the case is omitted and the drawing is nevertheless shown in the drawn-back state for improved illustration.

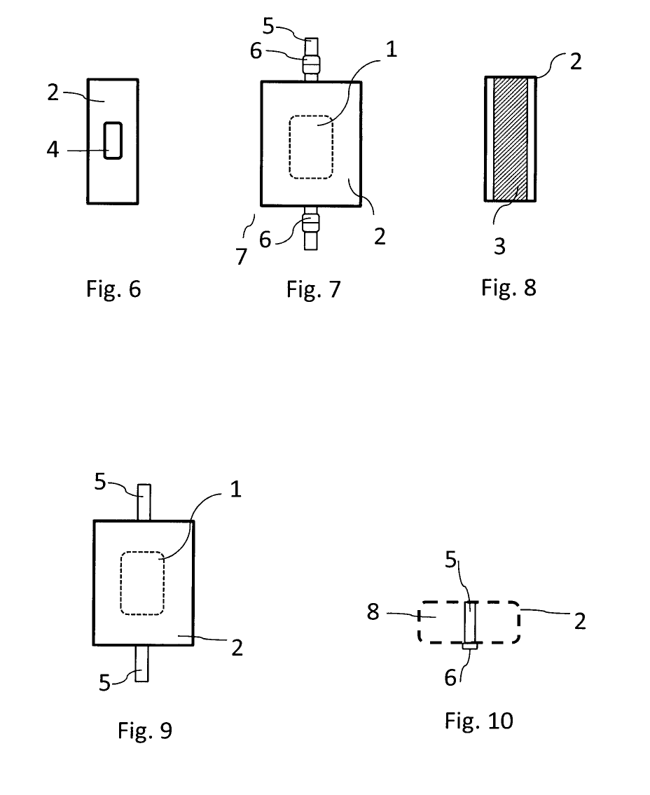

### DETAILED DESCRIPTION OF THE INVENTION

The covering (7) according to the invention can be drawn back onto a suitcase. To this end the closing mechanism (6) of the belts (5) is opened or left open. The cover (2) is drawn back onto the case by one of the exactly two tube openings (8). When the cover (2) is arranged completely on the case, the belts (5) can be connected to each other in a fixed manner by the closing mechanism (6). In this case the belts can be passed through a handle of the case, if present. As a result, the cover is fixed by the partially resilient portion (3) of the cover (2) in one direction on the one hand and by the closed belts in the direction at a right angle thereto on the other hand.

The cover (2) according to the invention has, in particular, the advantage that it contains a resilient portion (3). As a result, it is possible to use the cover (2) with suitcases of different sizes, and this allows a flexible usage. The resilient portion (3) also allows the cover (2) to be fixed closely adjacent. In addition, it is easy for the tube openings (8) of the cover (2) to be freed by opening the closing mechanism (6) and then for the cover (2) to be pulled off. It is also possible, by stretching the resilient portion (3), for the case to be opened at least slightly without the cover (2) being pulled off.

The covering (7) can fulfil various functions. On the one hand, as a protective cover it can protect the case from signs of use. On the other hand, the cover (2) can also be printed, either directly or by way of a patch to be fixed on the cover (2). The imprint can be designed in accordance with the wishes of the purchaser or the manufacturer. In particular, it can contain logos, writing, images, colours or the reproduction of trade marks.

The invention relates to a covering (7) for suitcases, comprising a tubular cover (2) which is capable of being drawn back over a suitcase or—synonymously—pulled over it respectively and which is open on both sides and comprises at least two different portions produced from different materials, at least one portion (3) of the cover joining the two tube openings (8) and consisting of a resilient material; and at each tube opening (8) a belt (5) which traverses the tube opening (8) and is provided with a re-closable mechanism (6), the ends of the belt (5) being fastened opposite each other on the respective tube opening (8).

A suitcase in the sense of the invention is any case onto which a covering (7) according to the invention can be drawn back. In particular, the cases can have a substantially rectangular or cuboidal shape. The cases can have a length which exceeds the width of the case. The length can correspond to 1.25×, 1.5×, 175×, 2.00× or from 1.25× to 2.00× the width of the case. The depth of the case can correspond to 0.25×, 0.5×, 0.75× or from 0.25× to 0.75× the width of the case. As a rule, the case will therefore comprise two short narrow sides, two long narrow sides and two wide sides which are part of the top half shell and the bottom half shell. One of the narrow sides is the handle side and one the standing side. The case can have carrying handles (9, 10) or handles. The case can have carrying handles (9, 10) on at least two sides. The handles (9, 10) are, in particular, attached to a short and a long narrow side.

The expression “tubular” is understood to be a cover (2) in the form of a tube open on both sides. This tube can be drawn back completely over the case, i.e. two opposite sides of the case are not covered by the cover (2).

The portions from which the cover (2) is formed are textiles. They can be woven or spun. They can be single-layered or multiple-layered. One portion (3) is produced from a resilient material. The resilience must be sufficient to ensure the secure fitting of the cover. Resilient materials are for example nylon, polyester, spandex (elastane, Lycra) or jersey. The respective portions can have a rectangular shape. In this way, the cover (2) can comprise a rectangle for the resilient portion (3) and a rectangle for the non-resilient portion. These can be processed by being joined to each other at two opposite side of a rectangle in each case to form a tube. The process applies accordingly to covers (2) with a plurality of resilient portions.

Re-closable mechanisms (6) for belts (5) are known from the prior art. In particular, snap closures, as also present hitherto on belts for cases, press studs or hook-and-loop fasteners, clip buckles, metal buckles, carabiners, waistband buckles, collar buckles or buttonhole systems, are suitable. Combinations of these re-closable mechanisms (6) are possible, only mutually compatible closable mechanisms being used at each tube opening. The closure mechanisms (6) of the two tube openings (8), however, can be different. As a rule, the closure mechanisms comprise two matching parts (in FIGS. 2 and 7 the mechanism (6) is recognizable as an upper and lower matching part) which form a fixed but separable connection by their co-operation as a result of being pressed one onto or into the other.

Belts (5) or—used synonymously in this case—straps in the sense of the invention are elongate and flat textile strips which have a high tensile strength. At least one end of a belt (5) is fixed at one of the two narrow sides thereof to one of the tube openings (8). The fixing can be carried out by way of seams, rivets or adhesion or a combination thereof. One matching part of the re-closable mechanism (6) is attached to the other narrow side of the belt (5). The other matching part can be attached directly to the textile which forms the tube opening (8). The other matching part can also, however, be fastened to a further belt (5) or belt part respectively which is likewise fastened to the tube opening (8). The re-closable mechanisms (6) are fastened to the belts (5) and the cover (2) by way of seams, rivets or adhesion. The re-closable mechanism (6) can contain an opening which has a suitable shape and size for a belt (5) to be passed through. The belts (5) can be passed through this opening and the portion of the belt (5) passed through can be folded back upon itself for fastening purposes, it being possible for the fastening again to be carried out by way of seams, rivets or adhesion.

The belt (5) is fastened to the respective tube opening (8) opposite. This means that, in the plan view of the opening (8) in which the opening (8) appears as a circle, the belts are attached at the point at which a tangent of the length of the diameter of the circle intersects the circle. It is preferable for the belts (5) to be attached to the two openings (8) in such a way that the belts (5) are parallel to each other in the closed state.

In an alternative embodiment the cover (2) has no belt at one of the two tube opening[s] (8). Instead, the cover (3) at this tube opening (8) is designed in such a way that the tube opening (8) is smaller as compared with the second tube opening (8) and cannot be drawn back completely over the case. This tube opening (8), however, is sufficiently large to leave a carrying handle uncovered. The cover (2) can become narrower at this point in order to permit a better fitting on the case.

A portion of the cover (2) can be capable of having printing or can be provided with a patch. This portion (3) preferably has an outline and an area by which, after the cover has been drawn back onto the case, it occupies the area of one side of the case completely or at least up to 25%, 50% or 75% or at most up to 25%, 50%, 75% or 100%. Areas which comprise combinations of these upper and lower limits—provided they are reasonable—are also included. In the sense of the present invention “at least” includes the value indicated respectively and the values above. The side is preferably one or both of the wide sides of the suitcase described above. In this way, possible imprints or advertising media on the side of the case are easily visible. Two advertising imprints can be applied to opposite sides of the cover so that after it has been drawn back over a suitcase the imprints are visible on the two wide sides of the case.

At least one imprint or advertising imprint can be applied to the printable portion of the cover (2) or patch. It is also possible, however, for two, three, four, five, six or more imprints to be on the covering (2). It is preferable for the cover (2) to contain two imprints. It is preferable for these imprints to be applied to opposite sides of the cover (2) so that after it has been drawn back over a suitcase the imprints are visible on the two wide sides of the case.

The cover can additionally comprise a further opening (4) as a gap for a handle (10) of the case on one of the sides of the cover (2). This means that the opening (4) is preferably formed on a side of the cover which is situated over one of the handles (10) after the drawing back has taken place. It is preferable for this to be one of the narrow sides of the case. An example of such an embodiment is in the Figures.

At least one portion of the covering can consist of a non-resilient material. Non-resilient materials are not deformable under tensile stressing. Non-resilient materials can be cotton, Chiffon, velour, Viscose, synthetic leather, satin, silk, patent material, awning fabric, damask, non-woven fabric (fleece material), sailcloth, cotton, coated, PVC tarpaulins (HGV tarpaulins), polyethylene (fabric tarpaulins, ribbon material).

The at least one portion (3) of the resilient material can occupy at most 5%, 10%, 15%, 20% or 25% of the area of the cover (2) or can occupy between 5 to 25%, 10 to 20%, 15 to 20% of the area of the cover. The portion (3) with the resilient material can be designed in such a way that it covers one side, preferably one narrow side of a case, completely or at least up to 20%, 30%, 40%, 50%, 60%, 70%, 80%, 90%. The cover can also have two, three or four resilient portions (3) which are separated from one another by non-resilient portions (1).

The cover (2) can have exactly two resilient portions (3) along the periphery. The two resilient portions (3) are arranged at an equal distance from each other on the cover in both peripheral directions. The portions between the resilient portions (3) are preferably formed from non-resilient material.

The imprint or advertising imprint can be applied in the portion (1) which consists of non-resilient material. In this way, the imprint does not become warped after drawing back onto the case has taken place.

Two advertising imprints can be applied on opposite sides of the cover.

The belt (5) can comprise two parts and the re-closable mechanism (6) can be attached to the free ends of the belt parts. The belt parts of an opening (8) can be of different or equal lengths. One belt part can be exactly or at least 1.5×, 2.0×, 3.0×, 5.0×, 7.5× or at least 10.0× as long as the second belt part. The belts (5) or belt parts can be longitudinally displaceable, and this allows the covering (7) to be adapted to different sizes of cases. The length of a belt (5) or belt part can allow a variation of the length from at least the factor 2 to the factor 10.

The belt parts are fastened to the non-resilient portions (1) of the cover (2). Each of the parts of a belt (5) is arranged on the cover (2) at an equal distance from the resilient portion (3), preferably each of the two resilient portions (3), in the peripheral direction. The belt parts are preferably arranged centrally on the non-resilient portion (1) along the periphery.

The covering (7) can be drawn back onto a suitcase and can be fixed on the suitcase by closing the re-closable mechanism.

1. A covering for suitcases comprising
a) a tubular cover (2) which is capable of being drawn back with two tube openings (8) over a suitcase and which along a periphery of the tube has at least two different portions (1, 3) produced from different materials, wherein at least one portion (3) of the cover (2) joins the two tube openings (8) and consists of a resilient material, and
b) at each tube opening (8) a belt (5) which traverses the tube opening (8) and is provided with a re-closable mechanism (6), wherein the ends of the belt (5) are fastened opposite each other at the respective tube opening (8).

2. A covering according to claim 1, wherein at least one portion (1) of the covering is capable of being printed on or is provided with a patch.

3. A covering according to claim 2, wherein at least one imprint or advertising imprint is applied to the cover (2) or the patch.

4. A covering according to claim 1, additionally comprising a further opening (4) on the side of the cover (2) as a gap for a handle of the case.

5. A covering according to claim 1, wherein at least one portion (1) consists of a non-resilient material.

6. A covering according to claim 1, wherein the at least one portion (3) with the resilient material occupies at most 5%, 10%, 15%, 20% or 25% of the area of the cover (2).

7. A covering according to claim 5, wherein the advertising imprint is applied in the portion (1) which consists of non-resilient material.

8. A covering according to claim 1, in which two advertising imprints have been applied to opposite sides of the cover (2).

9. A covering according to claim 1, in which the belt (5) comprises two parts and the re-closable mechanism (6) is attached to the free ends of the belt parts.

10. A covering according to claim 1, which has been drawn back onto a suitcase and has been fixed to the suitcase by closing the re-closable mechanism (6).
